(19) United States
(12) Patent Application Publication
(10) Pub. No.: US 2013/0005614 A1
(43) Pub. Date: Jan. 3, 2013

(54) SILICON STRUCTURE, ARRAY SUBSTRATE USING THE SAME AND METHOD FOR PRODUCING SILICON STRUCTURE

(75) Inventors: Takeki YAMAMOTO, Hyogo (JP); Masaya Nakatani, Hyogo (JP); Makoto Takahashi, Osaka (JP)

(73) Assignee: PANASONIC CORPORATION, Osaka (JP)

(21) Appl. No.: 13/608,801

(22) Filed: Sep. 10, 2012

Related U.S. Application Data
(63) Continuation of application No. PCT/JP2011/006785, filed on Dec. 5, 2011.

(30) Foreign Application Priority Data
Dec. 7, 2010 (JP) 2010-272195

(51) Int. Cl. C40B 60/14; B05D 3/06; B05D 3/02; B05D 1/36

(52) U.S. Cl. 506/40; 427/331; 427/535; 427/397.7

(57) ABSTRACT

A silicon structure has a substrate, a first layer formed on a surface of the substrate, and a fibrous film formed on a surface of the first layer. The first layer and the fibrous film are silicon compounds made of the same elements, and the first layer and the fibrous film are directly bonded together.

This application is a Continuation of International Application No. PCT/JP11/006785, filed on Dec. 5, 2011, claiming priority of Japanese Patent Application No. 2010-272195, filed on Dec. 7, 2010, the entire contents of each of which are hereby incorporated by reference.

### TECHNICAL FIELD

The present subject matter relates to a silicon structure used for a biochip such as a microfluid chip or a cell culture chip, an array substrate such as a DNA array, a protein array or a sugar chain array using the same, and a method for producing the silicon structure.

### BACKGROUND ART

As one example of applications using a silicon structure, biochips have been receiving attention in recent years. The biochip measures proteins, genes and low-molecular weight signal molecules based on a molecular recognition mechanism of an organism. Molecules are measured by monitoring using a certain device concerning selective specific binding such as receptor, ligand, aptamer, lectin, antigen-antibody reactions and selective catalytic reactions of enzymes and the like.

In recent years, array substrates having biochips have been used in various analyses such as gene analyses, SNPs (single nucleotide polymorphisms) analyses and substance interaction analyses in medical and pharmaceutical fields for innovative drug development and clinical diagnosis.

In such a biochip, reaction field regions are preliminarily provided on a surface of a base, an intended substance for detection is fixed for each of the reaction field regions, and a solution as a sample is then added dropwise. Then, interaction is allowed to progress between the substance for detection and a target substance contained in the sample, and a level of the interaction is detected by fluorescence intensity or the like to perform an analysis. A substrate that is used for such a process is referred to as an array substrate.

In the array substrate, in order to improve a detection sensitivity, it is necessary to increase interaction intensity in a reaction field region where interaction with a detection substance occurs. To achieve this, it is required to increase the surface area of the reaction field region. For example, the surface area can be increased by providing the reaction field region a fibrous or porous film.

For the conventional biochip, however, the biochip is warped due to a difference in heat expansion coefficient between a base and a reaction site formed on a surface of the base, and if adhesiveness between the base and the reaction site is low, the reaction site may be detached.

For example, when fibers of silicon oxide are provided as a reaction site on a base made of silicon by direct bonding, the biochip may be warped due to a difference in heat expansion coefficient between silicon and silicon oxide. That is, since silicon has a heat expansion coefficient greater than that of silicon oxide, warping may occur such that the center of the silicon base is raised, leading to detachment of the reaction site from the base.

Further, even if the reaction site is not detached, the detection accuracy in measurement of the array substrate using these biochips may be reduced because the reaction site is warped.

For accurately measuring a sample using an array substrate, it is required that diameters of spots formed when adding droplets to biochips provided on reaction sites be uniform. However, if the reaction site is warped, droplets added to biochips spread to a large extent during measurement, and spot diameters become nonuniform. As a result, the detection sensitivity may be reduced, or an accurate concentration may be no longer determined. Further, a droplet may be mixed not in an intended biochip but in an adjacent biochip, and thus it may be difficult to make accurate measurement.

There may be cases where an accurate analysis cannot be made due to nonuniform spot diameters, and resultantly the detection accuracy of the array substrate is reduced.

### SUMMARY

A silicon structure of the present disclosure has a substrate, a first layer formed on a surface of the substrate, and a fibrous film formed on a surface of the first layer. The first layer and the film are silicon compounds made of same elements, and the first layer and the film are directly bonded together.

An array substrate of the present disclosure has a plate, and a plurality of silicon structures described above, which are placed on the plate.

In a method of the present disclosure for producing a silicon structure, a first layer made of a silicon compound is formed on a surface of a substrate, a second layer having silicon as a main component is formed on a surface of the first layer, and a fibrous film is formed on the surface of the first layer using the second layer as a source material.

### BRIEF DESCRIPTION OF DRAWINGS

FIG. 1 is a perspective view of an array substrate in accordance with an exemplary embodiment of the present disclosure.

FIG. 2 is a sectional view taken along the line 2-2 of the array substrate in FIG. 1.

FIG. 3 is a sectional view of a silicon structure in accordance with the exemplary embodiment of the present disclosure.

FIG. 4A is a sectional view for explaining a method for producing a silicon structure in accordance with the exemplary embodiment of the present disclosure.

FIG. 4B is a sectional view for explaining a method for producing a silicon structure in accordance with the exemplary embodiment of the present disclosure.

FIG. 4C is a sectional view for explaining a method for producing a silicon structure in accordance with the exemplary embodiment of the present disclosure.

FIG. 5 is a sectional view of another silicon structure in accordance with the exemplary embodiment of the present disclosure.

FIG. 6 is a sectional view of another array substrate in accordance with the exemplary embodiment of the present disclosure.

### DESCRIPTION OF EMBODIMENTS

As one example of using a silicon structure in this embodiment, a biochip and an array substrate using the biochip will be described below with reference to the drawings. However, the present subject matter is not limited to the embodiment described below.

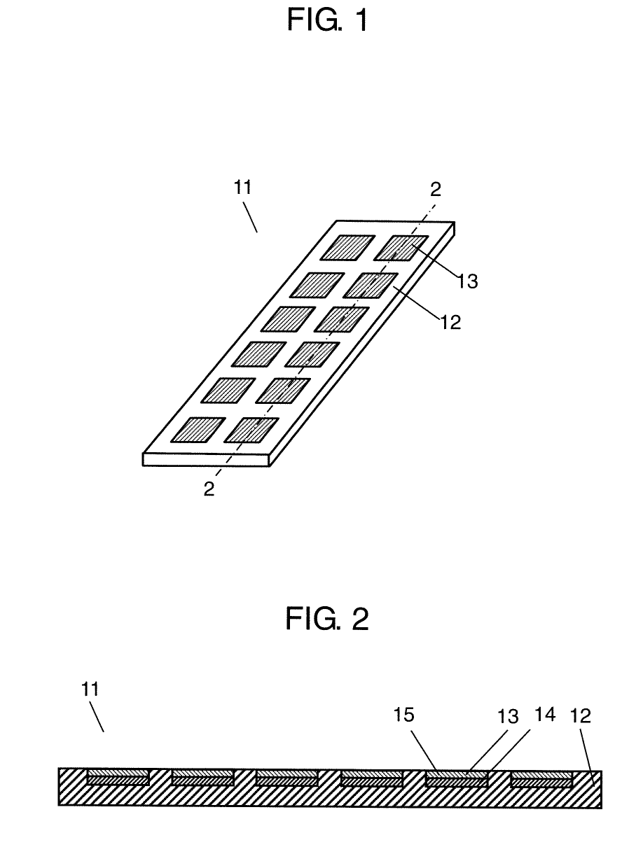

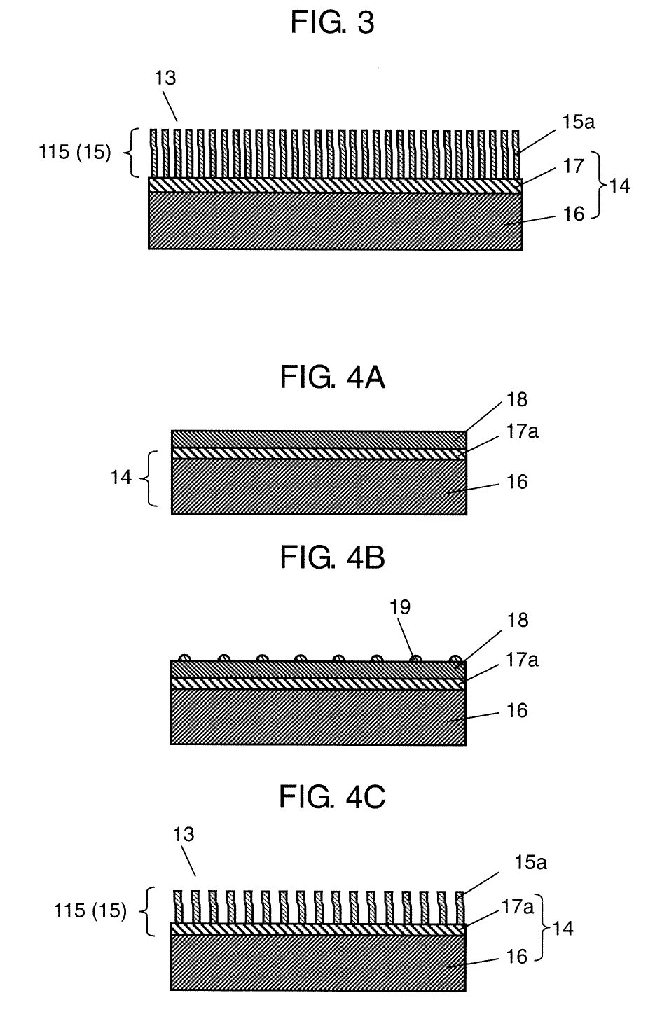

FIG. 1 is a perspective view of an array substrate in accordance with an exemplary embodiment of the present disclosure. FIG. 2 is a sectional view taken along the line 2-2 of the array substrate in FIG. 1. FIG. 3 is a sectional view of a silicon structure in accordance with the exemplary embodiment of the present disclosure.

As shown in FIG. 1, array substrate 11 has plate 12 including a resin provided with a plurality of recesses, and substantially square silicon structures 13 (biochips) each embedded in the recess. As shown in FIG. 2, silicon structure 13 has base 14 and reaction site 115 (film 15) formed on a surface of base 14. As shown in FIG. 3, the silicon structure 13 of this embodiment has substrate 16, base surface layer (first layer) 17 formed on a surface of substrate 16, and fibrous film 15 formed on a surface of base surface layer 17. Base surface layer 17 and film 15 are silicon compounds made of same elements, and base surface layer 17 and film 15 are directly bonded together. If silicon structure 13 is substantially square, the length of one side of each silicon structure 13 is about 100 μm to 10 μm. Reaction site 115 is made of a plurality of fibers 15a, and fibers 15a and base 14 are directly bonded together. Fiber 15a has silicon oxide as a main component. Here, “direct bonding” refers to a state in which reaction site 115 is formed directly on base 14, and atoms or molecules constituting base 14 and reaction site 115 are directly bound, normally a state in which molecules are covalently bound together. In this embodiment, silicon atoms of base surface layer 17 and silicon atoms in fiber 15a are covalently bound via oxygen atoms. No adhesive or the like is used in bonded surfaces of base 14 and reaction site 115, and no material other than atoms or molecules constituting base 14 and reaction site 115 is included.

In this embodiment, a silicon substrate formed of single crystal silicon is used for substrate 16. However, besides, for example, polycrystalline silicon, silicon oxide, quartz, borosilicate glass, amorphous silicon and the like can be used for substrate 16.

Reaction site 115, i.e. film 15 is made of for example, fibers 15a having silicon oxide as a main component, preferably fibers 15a having amorphous silicon dioxide as a main component.

For base surface layer 17 and film 15, silicon compounds such as polycrystalline silicon, quartz and borosilicate glass can be used besides silicon oxide and amorphous silicon dioxide.

The diameter of fiber 15a is about 0.01 μm to 1 μm. Fibers 15a may be formed in such a manner as to be densely intertwined, or may be formed such that fibers branching in random directions coexist. Fibers 15a are intertwined to form film 15, whereby reaction site 115 is strongly bonded to base 14. Reaction site 115 is also strongly bonded to base 14 when fibers 15a branch in multiple directions. Alternatively, a plurality of fibers 15a may be oriented in the same direction. It is more desirable for a plurality of fibers 15a to be oriented in various directions because fibers 15a are intertwined to thereby strongly bond reaction site 115 and base 14 together.

Conventionally, a transfer process has been utilized to obtain fibrous film. For example, in a nanoimprint process, a vessel raw material is heated and thereby softened, a mold provided with projections, i.e. features defining a culture surface is pressed against the vessel raw material to thereby transfer the features of the mold, so that a group of projections is formed in the vessel. However, this embodiment is preferable because there can be formed reaction site 115 that is narrower and has a larger surface area as compared to the conventional transfer process.

When silicon structure 13 is used as a biochip as in this embodiment, film 15 formed on base surface layer 17 can be used as reaction site 115 that can carry out various reaction analysis.

For example, base surface layer 17 is formed of silicon oxide layer 17a formed on at least a part of a surface of substrate 16. Film 15 is formed of a plurality of fibers 15a having silicon oxide as a main component. A surface of base surface layer 17 on which fibers 15a are fixed and fibers 15a are directly bonded together.

A representative method for producing silicon structure 13 in this embodiment will now be described. FIGS. 4A to 4C are a sectional view for explaining a method for producing silicon structure 13 in accordance with the exemplary embodiment of the present disclosure.

As shown in FIG. 4A, silicon layer 18 (second layer) having silicon as a main component is formed on a surface of base 14 having silicon oxide layer 17a. As a substrate having silicon layer 18 formed on the surface of base 14, a substrate that is already provided with the necessary layer may be purchased. For example, an SOI (silicon-on-insulator) substrate having three layers such that silicon oxide layer 17a is laminated on an upper surface of substrate 16 and silicon layer 18 is laminated on an upper surface of silicon oxide layer 17a, i.e. the surface of base 14, can be used. If the SOI substrate is used, high-purity fibers 15a can be formed because silicon layer 18 is made of single crystal silicon containing no impurity.

Silicon layer 18 is coated with catalyst 19 such as platinum as shown in FIG. 4B, and fibers 15a are formed until the surface of the base 14 is formed into base surface layer 17, i.e. silicon oxide layer 17a using silicon layer 18 as a source (raw) material as shown in FIG. 4C. By using silicon layer 18 as a raw material of fibers 15a in this way, silicon oxide layer 17a of base 14 and fibers 15a are directly bonded together.

The surface of silicon oxide layer 17a of base 14 is a very smooth flat surface having an RMS roughness of 10 nm or less.

If silicon oxide layer 17a is formed on at least a part of a surface facing reaction site 115, detachment of reaction site 115 from base 14 can be inhibited. The reason is because a part of a contact part with base 14 and a reaction site 115 is comprised of same main components.

At this time, it is desirable to fully consume silicon layer 18, but an adequate effect is obtained even if silicon layer 18 more or less remains on base surface layer 17 where film 15 and base surface layer 17 are not directly bonded together.

In this way, silicon layer 18 (second layer) having silicon as a main component can be formed on the surface of base 14 having silicon oxide layer 17a, and fibers 15a as fibrous film 15 can be formed using silicon layer 18 as a raw material.

An effect of silicon structure 13 of this embodiment will be described below. With features described in this embodiment, it is possible to prevent film 15 (reaction site 115) provided on silicon structure 13 from being detached, and to increase the detection accuracy of the array substrate using silicon structure 13.

As described above, conventionally, the biochip is warped due to a difference in heat expansion coefficient between the base of the biochip and the reaction site formed on the surface of the base, and if adhesiveness between the base and the reaction site is low, detachment may occur. Particularly when fibers made of silicon oxide are provided on the base made of silicon by direct bonding, the biochip may be warped due to a difference in heat expansion coefficient between silicon and silicon oxide. A plurality of fibers are not projections, but formed as a film, the fibers are intertwined on a one-by-one basis, and the film and the base are directly bonded together. Further, since silicon has a heat expansion coefficient greater than that of silicon oxide, the heat expansion coefficients of the substrate and the reaction site are mutually different, and the entire film made of fibers is thus subject to stress (displacement). As a result, fibers may be detached from the base due to occurrence of warping such that the center of the silicon base is raised.

However, by using the same main components for base surface layer 17 and reaction site 115, connection between base surface layer 17 and reaction site 115 can be improved, and detachment of fibers 15a from base 14 can be reduced. That is, in silicon structure 13 of this embodiment, fibers 15a made of silicon oxide are formed using silicon layer 18 as a raw material for using the same components for base surface layer 17 and reaction site 115. By forming fibers 15a, even though a plurality of fibers 15a are formed as a film and directly bonded to base surface layer 17, it is less likely that the fibers 15a detach from the base layer 17.

As described in the back ground art, a contact part of different kind materials is provided in a form of point contact. In contrast in this embodiment, the components of base surface layer 17 and reaction site 115 are the same, and therefore a contact with base surface layer 17 and reaction site 115 can be improved, and a contact part of different kind materials can be provided in a form of surface contact rather than point contact. Thus, detachment of reaction site 115 from base 14 can be reduced.

Again, reaction site 115 is not directly bonded to the silicon layer having a different heat expansion coefficient, but directly bonded to silicon oxide layer 17a having a component same as that of reaction site 115. Thus, stress on reaction site 115 can be reduced and detachment and warping can be suppressed.

Owing to inhibition of warping, a sample solution added dropwise to silicon structure 13 is trapped on reaction site 115 of silicon structure 13 without increasing the spot diameter of the sample solution at the time of measurement using array substrate 11. Thus, the detection sensitivity is not reduced and interaction can be reliably induced. Further, inhibition of warping eliminates a situation in which the added sample solution is not mixed in intended silicon structure 13 but unintentionally mixed in adjacent silicon structure 13. Thus, spot diameters and concentrations of sample solutions in silicon structures 13 are equalized. Therefore, analysis accuracy is improved, and array substrate 11 having high detection accuracy is obtained.

Fiber 15a is made from a silicon layer as a source material and is not made from silicon dioxide as a source material. In this embodiment, a formation reaction of reaction site 115 is stopped on silicon oxide layer 17a. By placing the silicon oxide layer, the thickness of base 14 can be made uniform. Therefore, positional accuracy of silicon structure 13 is improved, and detection accuracy is improved as well.

Since fibers 15a having silicon oxide as a main component is used as reaction site 115, fluorescence intensity originating in a material of reaction site 115 (i.e., silicon oxide) decreases, thereby reducing noises in a fluorescence intensity measurement. Further, fiber 15a having silicon oxide as a main component is a chemically stable material, and therefore can be subjected to various surface treatments. Further, by using fibers 15a having silicon oxide as a main component, the surface area per unit area can be increased to improve detection accuracy.

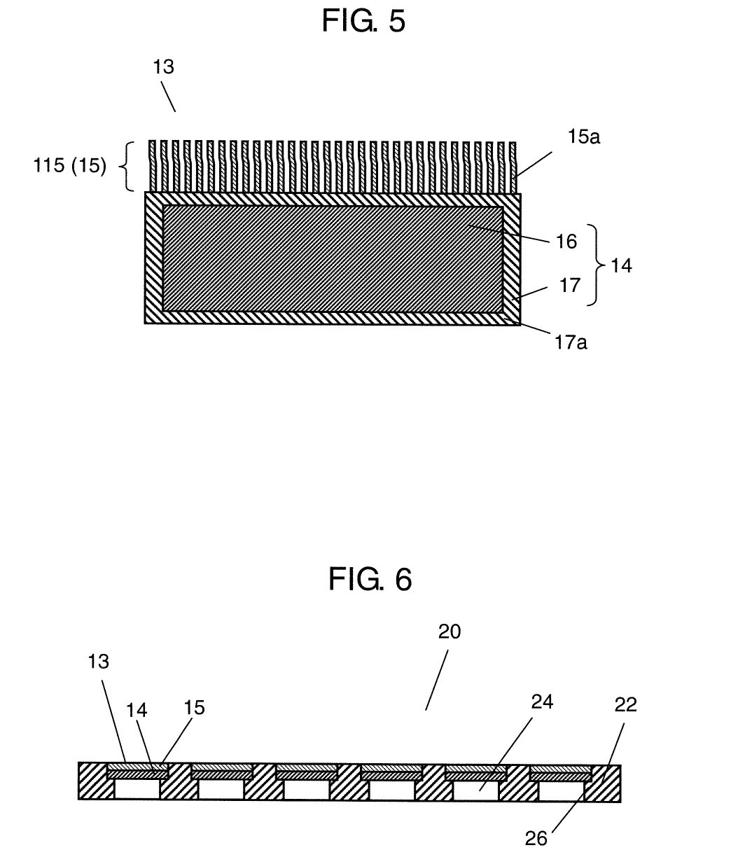

FIG. 5 is a sectional view of another silicon structure in accordance with the exemplary embodiment of the present disclosure. In this embodiment, silicon oxide layer 17a is also formed on the surfaces other than a bonding area with reaction site 115. That is, silicon oxide layer 17a is formed so as to cover the entire surface of base 14.

For example, fibers 15a as reaction site 115 are formed on base 14, and silicon oxide layer 17a made of the same material of fibers 15a is then formed on the side surface and the back surface of base 14 to coat the entire surface layer of substrate 16 with silicon oxide layer 17a.

In this case, silicon oxide layer 17a may be formed only on a surface facing reaction site 115. However, it is more preferable that silicon oxide layer 17a is formed isotropically to substrate 16, because warping of base 14 caused by silicon oxide layer 17a can be further reduced.

As a method for forming silicon oxide layer 17a so as to cover the entire surface of substrate 16, a CVD method, a sputtering method, a CSD method, thermal oxidation and the like may be used. The method by thermal oxidation is desirable from the viewpoint of productivity because no expensive vacuum apparatus is required, and a plurality of substrates can be treated all at once by a simple method. In the thermal oxidation, wet oxidation may be used, in which base 14 is placed in a quartz tube, a furnace is heated to 900° C. to 1150° C., an oxygen gas and a hydrogen gas are fed at a ratio of 1:2 to produce water vapor (H₂O) in the vicinity of an inlet of the furnace, and the water vapor is fed to the surface of base 14 to oxidize the surface. Even if fibers 15a to hinder penetration of oxygen (O₂) are formed on the surface of base 14, the use of wet oxidation facilitates diffusion of O₂ over the surface of base 14 by an action of H₂O, and therefore production efficiency is improved.

Dry oxidation may also be used, in which an oxygen gas is fed from a gas inlet and a silicon layer on the surface of substrate 16 is oxidized to form silicon oxide layer 17a, and oxidation in an atmosphere where HCl or a halogen such as Cl₂ is added.

Quality of the resulting silicon oxide layer 17a formed by a CVD method or thermal oxidation can be determined by measuring its refractive index or density. A silicon oxide layer by a CVD method has a refractive index of about 1.46 and a silicon oxide layer by thermal oxidation has a refractive index of about 1.48. This refractive index is a value measured by ellipsometry using a He—Ne laser having a wavelength of 632.8 nm. The density of silicon oxide layer 17a is difficult to measure directly, and therefore can be analyzed from an etching rate of buffered hydrofluoric acid (BHF). If BHF (48% HF: 11 g NH₄F/680 ml H₂O) is used, the silicon oxide layer by the CVD method has an etching rate of about 20 Å/min and silicon oxide by thermal oxidation has an etching rate of about 6.8 to 7.3 Å/min.

Even if a method like those described above is not used, the following method may be used. In a step of forming fibers 15a, silicon structure 13 is formed at 1000° C. to 1100° C. as a first step. Next, the silicon structure 13 is heated to a softening temperature of fiber 15a or higher, i.e., 1200° C. or higher. Fibers 15a in a part fixed on base 14 (base surface layer 17) are heat-melted and fused to base 14 (base surface layer 17). As a result, an area of contact between base surface layer 17 and reaction site 115 can be increased. Thus, detachment of reaction site 115 from base 14 can further be reduced. At this time, it is not necessarily required to form fibers 15a at a temperature of 1200° C. or higher

In addition to the method described above for producing silicon structure 13, formed fibers 15a may be annealed in an atmosphere of NF₃ while being kept at a high temperature. By this annealing, silicon structure 13 is made harder to be warped, and detachment thereof can further be inhibited. This is because in an oxide film, Si—O—Si bonds are cleaved, a SiO₂ lattice becomes open and compressive stress is relieved. In this case, fluorine (F) remains in fibers 15a.

Alternatively, formed fibers 15a may be subjected to corona discharge to obtain the similar effect as the annealing. Fibers 15a before application of corona discharge are under compressive stress, and therefore have a refractive index of about 1.472, as is measurable by an ellipsometer or the like. However, when corona discharge is applied, the lattice is relieved, so that the refractive index becomes about 1.46. This effect can be achieved by carrying out a similar treatment using a plasma, besides corona discharge.

Reducing the film thickness of fiber 15a makes silicon structure 13 to be harder to be warped. The magnitude of warping of base 14 follows the Stoney equation. That is, warping of base 14 expands as the film thickness of fiber 15a increases. For preventing detachment of fibers 15a, it is preferable to reduce the film thickness of fiber 15a, and the film thickness is preferably about 30 μm.

In this embodiment, reaction site 115 is formed of fibers. A similar effect can be exhibited with any other forms having a high porosity and a large specific surface area of, for example, several m²/g, such as a porous film and nanotubes. It is preferable that reaction site 115 be made of an inorganic material which shows excellent in heat resistance and chemical resistance.

It is also preferable to use silicon (111) as silicon layer 18 to make silicon structure 13 to be harder to be warped. This is because intrinsic stress of silicon oxide depends on the crystal direction, and stress is the lowest when silicon (111) is used as silicon layer 18. Here, silicon (111) refers to silicon having a silicon (111) plane orientation, i.e., a (111) plane direction on a surface.

In place of the SOI substrate as described above, base 14 having silicon oxide layer 17a and silicon layer 18 on a part of substrate 16 may be used. For example, fibers 15a can also be formed using a polysilicon layer as a raw material by using a substrate made of a polysilicon layer/silicon oxide layer/silicon substrate and coating the polysilicon layer with a catalyst. Further, the layer as a raw material is not limited to a polysilicon layer, and may be a layer having silicon such amorphous silicon as a main component. The layer having silicon as a main component may be formed by a CVD (chemical vapor deposition) method, a CSD (chemical solution deposition) method or the like.

Particularly in the CSD method, silicon layer 18 can be easily formed on a surface of silicon oxide layer 17a by coating a dispersion of silicon particles in a solvent or a silicon ink or a sol-gel solution containing a Si raw material by a spin coating method. On the other hand, the CVD method is excellent in step coverage and suitable for forming a film in large quantity and at a high speed.

Further, if a polysilicon layer or an amorphous silicon layer is used for silicon layer 18, random and homogenous fibers 15a can be formed because the layer does not have anisotropy by crystals.

The thickness of fibrous film 15 can be control by the thickness of silicon layer 18. It is desirable that silicon layer 18 as a raw material of reaction site 115 should have a thickness of 20 μm or less, more preferably 10 μm or less. A speed at which reaction site 115 is formed decreases as the thickness of reaction site 115 increases. If the thickness is greater than 20 μm, formation of fibers 15a stops before silicon layer 18 as a raw material of reaction site 115 is consumed. Thus, it becomes difficult to form a desired structure. It is also desirable that silicon layer 18 as a raw material of reaction site 115 have a thickness of 1 μm or more to coat a surface of silicon oxide layer 17a.

This embodiment has been described with base 14 made of silicon, but base 14 may be wholly made of a material same as that of base surface layer 17. That is, base surface layer 17 and substrate 16 may be made of same elements. Further, base surface layer 17 and substrate 16 may be materials represented by the same compositional formula.

For example, as base 14 (i.e. base surface layer 17 and substrate 16), a material having silicon oxide as a main component may be used. That is, silicon oxide, glass, quartz, borosilicate glass or the like is used as base 14, on which a layer having silicon as a main component is formed by vapor deposition using a CVD method or a CSD method, or the like. Then, fibers 15a having silicon oxide as a main component may be formed using as a raw material the formed layer having silicon as a main component.

In this case, since base 14 and film 15 have same components, base 14 and film 15 have the same heat expansion coefficient, so that warping of the base itself can be reduced. That is, an effect of preventing detachment is further improved in comparison with the case where only base surface layer 17 and film 15 have same components.

It is preferable to use a translucent material such as quartz used as base 14 because it is thereby made easy to observe light transmitted through silicon structure 13.

As an alternative to the method shown in FIGS. 4A to 4C, substrate 16 may be used as a material for forming fibers 15a. In this case, fibers 15a will be formed on front and back surfaces of substrate 16. Therefore, silicon structure 13, both surfaces of which are usable as a reaction field, is formed. This is not limited to the SOI substrate. For example, it is also possible to form polysilicon layers on both surfaces of a quartz substrate and form fibers 15a on both surfaces of the quartz substrate.

As a material of reaction site 115, desirable is a material doped with an inorganic substance such as boron (B) or phosphorus (P). The softening temperature is relatively high, i.e. 1160° C. when undoped silicon oxide is used, while doped materials have a low softening temperature. For example, PSG (phosphosilicate glass) doped with phosphorus has a softening point of around 1000° C. and BSG (borosilicate glass) and BPSG (boron phosphorous silicon glass) have a softening point of about 900° C. Thus, by doping fibers 15a with B and P, a heat-melting temperature can be decreased, so that productivity is improved.

Plate 12 made of a resin is used in this embodiment, but plate 12 made of a material same as that of substrate 16 may be used, or substrate 16 may be integrated with plate 12. The number of steps in a production process can be thereby reduced.

FIG. 6 is a sectional view of another array substrate 20 in which a plurality of silicon structures 13 are arranged in an array on plate 22 in accordance with the exemplary embodiment of the present disclosure. As shown in FIG. 6, array substrate 20 may be configured such that plate 22 has through-holes 24 in an array form, and silicon structures 13 are embedded in through-holes 24. Alternatively, projections 26 may be provided on a lower surface of plate 22 in through-holes 24, and silicon structures 13 inserted to be fixed in such a manner as to contact projections 26. In this case, positioning of silicon structures 13 is easy, and heights of silicon structures 13 can be equalized.

Silicon structure 13 may be bonded onto a surface of plate 12 or plate 22 using an adhesive.

Further, it is desirable to store silicon structure 13 of this embodiment in an environment free from moisture or an environment having a reduced amount of moisture after it is produced and before it is actually used. If silicon structure 13 is stored in an environment free from moisture, a change in stress on fibers 15a as reaction site 115 can be reduced, so that long-term stability of silicon structure 13 is improved. In this case, the amount of moisture contained in stored fibers 15a decreases. The amount of moisture contained in fibers 15a can be quantified by using an analysis such as TDS (Thermal Desorption Spectrometry).

For storage in an environment free from moisture, silicon structure 13 is enclosed in a sealed package. For the package, for example, aluminum, or a resin of polydimethylsiloxane (PDMS), polypropylene, polycarbonate, polyolefin, polyethylene, polystyrene, polyamide, polymethyl methacrylate (PMMA), cyclic polyolefin or the like can be used.

The silicon structure is packaged together with a material that adsorbs moisture. The material that adsorbs moisture is, for example, silica gel, zeolite, lithium chloride or triethylene glycol, a moisture getter agent, or the like.

Alternatively, the package may be filled with a gas containing no moisture. The gas containing no moisture is desirably an inert gas such as N₂ or Ar, but may be a gas such as O₂ as long as it does not cause deterioration of silicon structure 13 and has a reduced moisture concentration. Air or a gas compressed under pressure may also be enclosed. In this case, moisture (amount of saturated water vapor) that can be contained in the air decreases, and it is therefore possible to provide a package having a reduced amount of moisture.

This embodiment has been described with reference to an example in which silicon structure 13 is used as a biochip, and further silicon structure 13 is used as array substrate 11, but is not limited thereto, and the silicon structure may be used as a microfluid chip or a cell culture chip. In this embodiment, reaction site 115 is used as a reaction field, but may also be used as an ion exchange adsorbent, a filter material, a gas sensor and an electrode, aside from the reaction field.

If a metal oxide is used as substrate 16, covalent binding is increased to provide an effect of inhibiting detachment. Metal oxide bases include sapphire, aluminum oxide, MgO, ZrO₂ and TiO₂, and the material is not limited.

Another example of the silicon structure in this embodiment will be described below. Film 15 of the silicon structure in FIGS. 3 to 5 is used as an ion exchange adsorbent.

The ion exchange adsorbent is used for clarification of waste water (adsorption of heavy metal ions), adsorption of various kinds of gases, auxiliaries for deoxidizers, dehydration of industrial gases, adsorptive separation of by-product gases and the like. By forming the ion exchange adsorbent with fibers 15a, higher reaction efficiency is obtained. When fibers 15a are used as an ion exchange adsorbent, it is desirable to form reaction site 115 in a microfluid chip. For example, by embedding reaction site 115 in the microfluid chip or by forming a channel groove on base 14 and forming reaction site 115 on a bottom surface of the groove, a device using an ion exchange adsorbent can be formed. If reaction site 115 formed in the microfluid chip is warped, a fluid resistance is increased or it is difficult for a fluid to pass uniformly. By using the same components for reaction site 115 and base surface layer 17, warping of the microfluid chip can be reduced. Consequently, the fluid resistance is reduced and the fluid is allowed to pass uniformly, whereby a highly reliable treatment can be performed. If it is necessary to seal base 14, bonding may be difficult due to warping of base 14, and warping is reduced by the present configuration to thereby improve reliability of bonding.

Still another example of the silicon structure in this embodiment will be described below. Film 15 of the silicon structure in FIGS. 3 to 5 is used as a filter material.

Film 15 extracts only a specific substance from a solution, and therefore can be used for various kinds of filter materials of separation filters, analytical filters, sterilization filter and the like. By forming the filter material with fibers 15a, higher separation efficiency is obtained. If the film is used as the filter material, it is desirable to form reaction site 115 in a channel device. For example, by embedding in the channel device the silicon structure having film 15, a device having a filter can be formed. The channel device can be a flat plate or of a capillary type. Alternatively, the channel device can be formed by forming a channel groove on base 14 and forming reaction site 115 on a bottom surface of the groove, or forming a channel groove on base 14, forming in a bottom surface of the channel groove a through-hole extending through base 14, and forming film 15 on an upper surface of the through-hole. A direction along which a sample solution is allowed to flow may be parallel or perpendicular to a surface at which film 15 and base 14 are bonded together.

If film 15 in the fluid device is warped, a fluid resistance is increased or it is difficult for a fluid to pass uniformly. By using the same components for reaction site 115 and base surface layer 17, warping of the channel device can be reduced. Consequently, the fluid resistance is reduced and the fluid is allowed to pass uniformly, whereby a highly reliable treatment can be performed. If it is necessary to seal base 14, bonding may be difficult due to warping of base 14, and warping is reduced by the present configuration to thereby improve reliability.

Still another example of the silicon structure in this embodiment will be described below. Film 15 of the silicon structure in FIGS. 3 to 5 is used as a detection material of a gas sensor.

Generally, as the detection material of a gas sensor, SnO₂, ZnO, ZrO₂, Y—ZrO₂ (yttrium-stabilized zirconia) and the like are used. In the case of SnO₂ and ZnO, a change in electric resistance caused by adsorption/reaction of a gas at a surface of an oxide semiconductor (surface of detection material) is detected. In the case of using ZrO₂ and Y—ZrO₂, a battery is formed with an ion conductor, and an electromotive force by a gas is detected by a detection material to thereby form a gas sensor. By using film 15 of a fibrous structure as a detection material, reaction efficiency is improved and a high detection capability is obtained.

In a structure of the gas sensor, it is desirable to make a detection part airtight from the viewpoint of detection sensitivity. If the gas sensor is formed by micro-fabrication, it is necessary to bond the base with other bonding materials (e.g. sealing material). The detection material is formed within a space formed by the base and the bonding material. If the base is warped as a result of using fibers 15a for the detection material, bonding with the bonding material is difficult. By using the same components for reaction site 115 and base surface layer 17, warping of the base and the electrode can be reduced, so that stability of bonding is improved. As a result, reliability of the gas sensor can be improved. These matters do not depend on the type of a detection material and the type of a gas to be detected.

Still another example of the silicon structure in this embodiment will be described below. Film 15 of the silicon structure in FIGS. 3 to 5 is used as an electrode of a battery.

Electrodes formed of different materials such as, for example, aluminum and cobalt are placed at both sides of an electrolytic solution, whereby if the electrodes have different ionization tendency coefficients, ions in the electrolytic solution move between the electrodes, so that a battery that takes out a current can be provided. For an electrode material of the battery, LiMn₂O₄, LiFePO₄, LiCoO₂, LiNiO₂, LixMeyO₂ and the like are used as a positive electrode. As a negative electrode, Li, Si, SiO, Sn—Me, Si—Me, C, HC, Li₄Ti₅O₁₂, La₃Co₂Sn₇ and the like are used. By forming these materials into fibers 15a, a high capacity, high reactivity, high-speed charge/discharge and the like are obtained.

The distance between electrodes is a factor which determines transit time of the above-mentioned ions, and the distance between electrodes is preferably as small as possible for facilitating the flow of ions, i.e. reducing the internal resistance of the battery. When the electrode material is formed with a fibrous structure, the internal resistance of the battery is no longer stable if the base and electrode are warped, and resultantly the distance between electrodes is changed. If the base and the electrode are more significantly warped, the risk of generating a short between electrodes increases. By using the same components for reaction site 115 and base surface layer 17, warping of the base and the electrode can be reduced. A highly reliable battery can be thereby formed.

Still another example of the silicon structure in this embodiment will be described below. The silicon structure in FIGS. 3 to 5 is used as a cell culture chip.

In recent years, use has been made of cell culture chips in culture techniques for skin implantation and implantation from a small amount of cells to complex body organs such as corneas, teeth, bones and organs as techniques of cell culture used for medical purposes have progressed.

For conventional cell culture chips, chips prepared by coating a vessel made of glass or resin with a material having a high affinity with cells are used. By using these chips, cells can be cultured on a surface having an affinity with cells, but adhesion between cultured cells and cell culture chips may be so strong that it is difficult to detach cells from cell culture chips. As a result, cultured cells may be physically damaged by being mechanically detached, and membrane proteins on cell surfaces may be collapsed by being detached by a chemical treatment using an enzyme such as trypsin, leading to a reduction in rate of fixation to cell tissues after implantation.

In the cell culture chip of this embodiment, cells can be cultured on film 15. By using the cell culture chip of this embodiment, moderate air gaps can be formed below cultured cells, so that cultured cells can be efficiently detached in comparison with conventional cell culture chips. Further, nutrients and waste products are more efficiently transported with the air gaps, so that culture efficiency can be further improved.

Further, warping of film 15 is inhibited, and therefore adjacent film 15 and cultured cells can be inhibited from being mixed together, so that contamination can be reduced.

When film 15 is coated with a material having water repellency, a culture solution is added dropwise thereon, and cells are cultured in the culture solution, it is difficult to stably retain the culture solution if warping of film 15 is significant. Thus, by using the silicon structure of this embodiment, the culture solution can be stably retained.

### INDUSTRIAL APPLICABILITY

The silicon structure of the present disclosure and the array substrate using the same are used for a biochip such as a microfluid chip or a cell culture chip and an array substrate such as a DNA array, a protein array or a sugar chain array.

### REFERENCE MARKS IN THE DRAWINGS

11, 20 array substrate
12, 22 plate
13 silicon structure (biochip)
14 base
15 film
15a fiber
16 substrate
17 base surface layer (first layer)
17a silicon oxide layer
18 silicon layer (second layer)
19 catalyst
24 through-hole
26 projection
115 reaction site

1. A silicon structure comprising:
a substrate;
a first layer formed on a surface of the substrate; and
a fibrous film formed on a surface of the first layer, wherein
the first layer and the fibrous film are silicon compounds made of same elements, and the first layer and the fibrous film are directly bonded together.

2. The silicon structure according to claim 1, wherein the first layer and the fibrous film are represented by a same compositional formula.

3. The silicon structure according to claim 1, wherein the first layer and the substrate are silicon compounds made of same elements.

4. The silicon structure according to claim 1, wherein the first layer and the substrate are represented by a same compositional formula.

5. The silicon structure according to claim 1, wherein the fibrous film is formed of silicon oxide.

6. The silicon structure according to claim 1, wherein the fibrous film is formed of amorphous silicon dioxide.

7. The silicon structure according to claim 1, wherein the fibrous film is formed of quartz or borosilicate glass.

8. The silicon structure according to claim 1, wherein the fibrous film is made of an inorganic material.

9. The silicon structure according to claim 1, wherein the fibrous film is doped with an inorganic substance.

10. A method for producing a silicon structure, the method comprising steps of:
forming a first layer made of a silicon compound on a surface of a substrate;
forming a second layer having silicon as a main component on a surface of the first layer; and
forming a fibrous film on the surface of the first layer by using the second layer as a source material.

11. The method for producing a silicon structure according to claim 10, further comprising:
forming a catalyst on the second layer, after the step of forming the second layer and before the step of forming the fibrous film.

12. The method for producing a silicon structure according to claim 10, wherein the first layer and the fibrous film are formed of silicon oxide.

13. A method for producing a silicon structure, the method comprising steps of:
providing an oxygen source gas to a silicon layer of a silicon-on-insulator substrate which includes a silicon substrate, an oxide layer on the silicon substrate, and the silicon layer on the oxide layer, and
forming a fibrous film on the surface of the oxide layer by using the silicon layer as a source material.

14. The method for producing a silicon structure according to claim 10, wherein a thickness of the second layer is less than 20 μm and more than 1 μm

15. The method for producing a silicon structure according to claim 10, wherein the second layer is formed of single crystal silicon.

16. The method for producing a silicon structure according to claim 10, wherein the second layer is formed of polysilicon or amorphous silicon.

17. The method for producing a silicon structure according to claim 10, wherein the second layer is silicon (111) plane-oriented.

18. The method for producing a silicon structure according to claim 10, further comprising a step of relieving a stress in the fibrous film.

19. The method for producing a silicon structure according to claim 18, wherein the step of relieving the stress includes applying a corona discharging to the fibrous film or annealing the fibrous film.

20. An array substrate comprising:
a plate; and
a plurality of silicon structures placed on the plate, wherein:
each of the plurality of silicon structures has a substrate, a first layer formed on a surface of the substrate, and a fibrous film formed on a surface of the first layer,
the first layer and the film are silicon compounds made of same elements, and
the first layer and the film are directly bonded together.
